(19) United States
(12) Patent Application Publication
(10) Pub. No.: US 2024/0283177 A1
(43) Pub. Date: Aug. 22, 2024

(54) Cable Connector Assembly and Method of Assembling the Same

(71) Applicant: Tyco Electronics (Shanghai) Co., Ltd., Shanghai (CN)

(72) Inventors: Lizhou (Leo) Li, Shanghai (CN); Xinjie (David) Zhang, Shanghai (CN)

(73) Assignee: Tyco Electronics (Shanghai) Co., Ltd., Shanghai (CN)

(21) Appl. No.: 18/581,923

(22) Filed: Feb. 20, 2024

(30) Foreign Application Priority Data
Feb. 20, 2023 (CN) 202310143351.7

(51) Int. Cl. H01R 12/75; H01R 12/70; H01R 43/20; H01R 43/24

(52) U.S. Cl. CPC H01R 12/75; H01R 12/707; H01R 43/205; H01R 43/24

(57) ABSTRACT

A cable connector assembly includes a connector having a first housing, a plurality of first connection terminals disposed in the first housing, a second housing, and a plurality of second connection terminals disposed in the second housing. The cable connector includes a plurality of cables respectively connected to the first connection terminals and a printed circuit board to which the second connection terminals are connected.

### CROSS-REFERENCE TO RELATED APPLICATION

This application claims the benefit of the filing date under 35 U.S.C. § 119(a)-(d) of Chinese Patent Application No. 202310143351.7, filed on Feb. 20, 2023.

### FIELD OF THE INVENTION

Embodiments of the present disclosure generally relate to electrical connectors and, in particular, to a cable connector assembly and a method of assembling the same.

### BACKGROUND

A connection between a PCIe connector and a cable is achieved by an interposer printed circuit board. The connector is soldered onto the printed circuit board and the cable is soldered onto the printed circuit board to achieve a cable connection between the connector and other electrical joints.

In practice, connection terminals of the connector are connected to the printed circuit board using via-holes. In order to ensure signal integrity (SI) during signal transmission (especially high-speed signal transmission), material and process requirements of the printed circuit board and its holes are quite high, so the cost is also quite high.

In addition, in the related art, both the connection terminals of the connector (including a high-speed signal transmission connection terminal and a low-speed signal transmission connection terminal) and the cable need to be soldered to the printed circuit board, so a larger size of the printed circuit board is required, which is not beneficial to saving the mounting space of the whole assembly. Moreover, a method of assembling the whole assembly is relatively complicated and the assembling cost is relatively high. A transfer mode adopting this interposer printed circuit board affects the SI performance during high-speed signal transmission and has high costs.

### SUMMARY

A cable connector assembly includes a connector having a first housing, a plurality of first connection terminals disposed in the first housing, a second housing, and a plurality of second connection terminals disposed in the second housing. The cable connector includes a plurality of cables respectively connected to the first connection terminals and a printed circuit board to which the second connection terminals are connected.

### BRIEF DESCRIPTION OF THE DRAWINGS

Features of the present invention will become more apparent by describing in detail exemplary embodiments thereof with reference to the accompanying drawings, in which:

FIG. 1 is a schematic perspective view of a cable connector assembly according to an embodiment;

FIG. 2 is a schematic perspective view of a connector and a cable of the cable connector assembly, with a first housing and a second housing of the connector separated from each other;

FIG. 3 is another schematic perspective view of the connector and the cable of the cable connector assembly, with the first housing and the second housing of the connector engaged with each other;

FIG. 4 is a schematic perspective view of a first stage of a method of assembling a cable connector assembly according to an embodiment;

FIG. 5 is a schematic perspective view of a second stage of the method of assembling the cable connector assembly;

FIG. 6 is a schematic perspective view of a third stage of the method of assembling the cable connector assembly; and

FIG. 7 is a schematic perspective view of a fourth stage of the method of assembling the cable connector assembly.

### DETAILED DESCRIPTION OF EMBODIMENTS

Embodiments of the present disclosure will be described hereinafter in detail taken in conjunction with the accompanying drawings. In the description, the same or similar parts are indicated by the same or similar reference numerals. The description of each of the embodiments of the present disclosure hereinafter with reference to the accompanying drawings is intended to explain the general inventive concept of the present disclosure and should not be construed as a limitation on the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

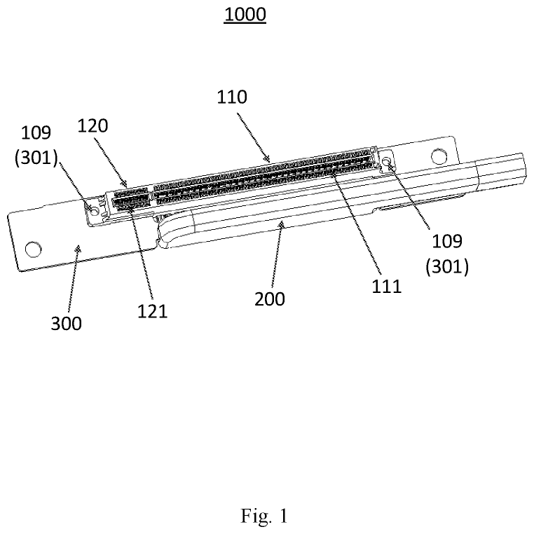

Referring to FIGS. 1 to 3, according to an embodiment of the present disclosure, there is provided a cable connector assembly 1000. The cable connector assembly 1000 includes: a connector 100, a plurality of cables 200 (being overmolded into one piece in FIG. 1), and a printed circuit board 300.

As shown in FIGS. 1 to 3, the connector 100 includes: a first housing 110, a plurality of first connection terminals 111 suitable for high-speed signal transmission provided in the first housing 110, a second housing 120, and a plurality of second connection terminals 121 suitable for low-speed signal transmission, such as power supply, provided in the second housing 120.

According to the embodiment of the present disclosure, the plurality of cables 200 are connected to the plurality of first connection terminals 111, respectively, and the plurality of second connection terminals 121 are connected to the printed circuit board 300. The first housing 110 and the second housing 120 of the connector 100 may be made of non-conductive materials such as plastic materials, and the first connection terminals 111 and the second connection terminals 121 may be made of conductive materials, for example, metals, such as copper. A conductive portion of the cables 200 may be made of conductive materials, for example, metals, such as copper. The printed circuit board 300 may be made by forming a conductive path (such as a pad) made of metals, such as copper, on non-conductive materials such as plastic materials.

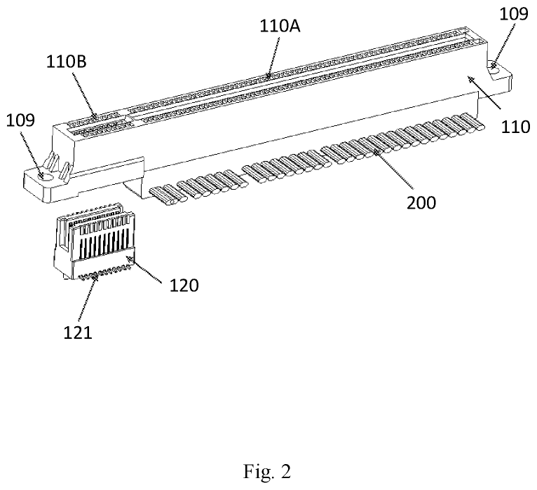

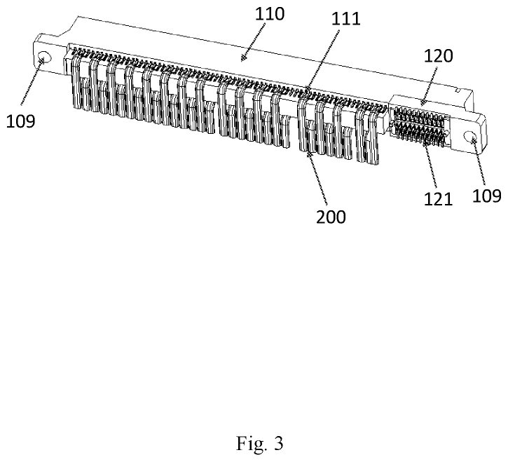

As shown in FIG. 3, in the exemplary embodiment illustrated, connection ends of the plurality of cables 200 are directly connected to one ends of the plurality of first connection terminals 111 by soldering, respectively, to achieve an effective connection between the cables 200 and the first connection terminals 111. Furthermore, after being connected together by soldering, the one ends of the plurality of first connection terminals 111 are combined with the connection ends of the plurality of cables 200 by over-molding, as shown in FIG. 2, thereby ensuring a stable connection between the cables 200 and the first connection terminals 111. In the exemplary embodiment illustrated, the connection ends of the cables 200 are directly connected to the one ends of the first connection terminals 111 by soldering but, in other exemplary embodiments, as long as the effective connection between the cable 200 and the first connection terminal 111 can be achieved, the connection ends of the cables 200 can also be directly connected to the ends of the first connection terminals 111 by plugging, crimping or other forms of connection.

The first housing 110 and the second housing 120 are separate components, and the first connection terminals 111 are not directly connected to the printed circuit board 300. Therefore, when there is a failure in the terminals 111 for transmitting high-speed signals or the connection between the terminal and the cable, it is easy to replace the component related to the high-speed signal transmission.

As shown in FIGS. 1 to 3, in the exemplary embodiments illustrated, one ends of the plurality of second connection terminals 121 are directly connected to a plurality of pads on the printed circuit board 300 by soldering, respectively, to achieve an effective connection between the second connection terminal 121 and the conductive path on the printed circuit board 300. Although in the exemplary embodiment illustrated, the one ends of the second connection terminals 121 are directly connected to the plurality of pads on the printed circuit board 300 by soldering, in other exemplary embodiments, as long as the effective connection between the ends of the second connection terminals 121 and the pads on the printed circuit board 300 can be achieved, the ends of the second connection terminals 121 can also be directly connected to the pads on the printed circuit board 300 by plugging, crimping, a via-hole connection or other forms of connection.

According to the cable connector assembly 1000 provided by the embodiments of the present disclosure, the first connection terminals 111 of the connector 100 suitable for the high-speed signal transmission are directly connected to the cables 200, which eliminates the connection between the first connection terminals 111 and the cables 200 through a via-hole on the printed circuit board 300, thus improving the SI performance and reducing the cost.

In the embodiments of the present disclosure, the connector 100 is a female electrical connector. The first housing 110 may further include, as shown in FIG. 2, a first slot 110A and a second slot 110B which is independent of the first slot 110A and integrated with the first slot 110A. The plurality of first connection terminals 111 are received in the first slot 110A, and the second housing 120 and the plurality of second connection terminals 121 are received in the second slot 110B. The second housing 120 and the plurality of second connection terminals 121 can be detachably received in the second slot 110B. With the above construction, the first housing 110 and the plurality of first connection terminals 111 provided therein form one independent body, and the second housing 120 and the plurality of second connection terminals 121 provided therein form another independent body. The two independent bodies are separated from each other and may be assembled with the cables 200 and the printed circuit board 300, respectively, when assembling the cable connector assembly 1000, thus facilitating the assembly process and saving the assembling cost.

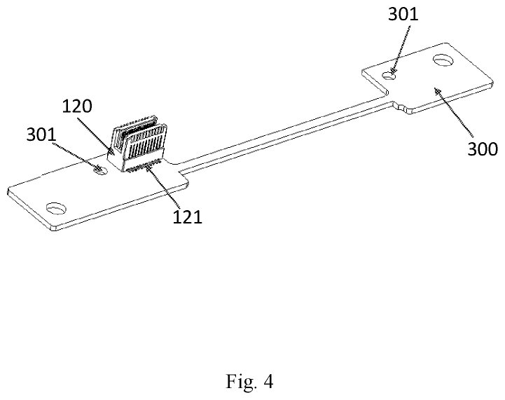

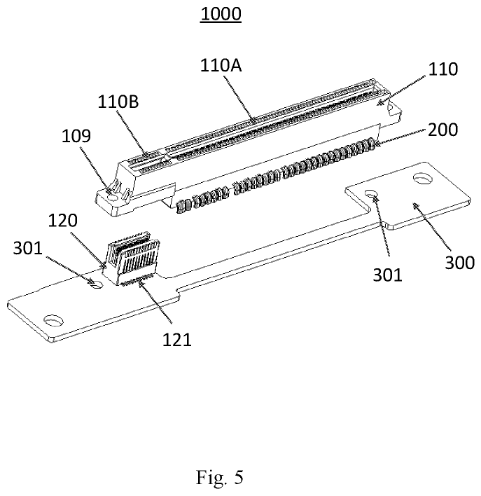

Continuing to refer to FIGS. 1 to 3 (as well as FIG. 5 to be described below), in the exemplary embodiment illustrated, opposite ends of the first housing 110 are provided with a first fixing portion 109. The printed circuit board 300 has a second fixing portion 301, as shown in FIG. 4, at positions corresponding to the opposite ends of the first housing 110. The first housing 110 may be fixed to the printed circuit board 300 by a fastener sequentially passing through the first fixing portion 109 and the second fixing portion 301. As shown in FIG. 1, the printed circuit board 300 has an elongated shape. The plurality of cables 200 are flexible and bendable and are configured to be able to being bent around the printed circuit board 300.

According to the cable connector assembly 1000 provided by the embodiments of the present disclosure, since the first connection terminals 111 of the connector suitable for the high-speed signal transmission are directly connected to the cables 200, without the need for connecting the first connection terminals 111 to the cables 200 by the printed circuit board 300, and a size of the printed circuit board 300 is reduced accordingly, the mounting space of the whole assembly 1000 is saved.

A method of assembling the cable connector assembly 1000 will now be described in greater detail. The assembling method is applicable to the aforementioned cable connector assembly 1000 according to the embodiment of the present disclosure.

The method of assembling the cable connector assembly 1000 includes: providing a connector 100 including: a first housing 110, a plurality of first connection terminals 111 provided in the first housing 110, a second housing 120, and a plurality of second connection terminals 121 provided in the second housing 120; connecting a plurality of cables 200 to the plurality of first connection terminals 111, respectively; connecting the plurality of second connection terminals 121 provided in the second housing 120 to a printed circuit board 300; and mounting a combination of the first housing 110, the plurality of first connection terminals 111 provided in the first housing 110, and the plurality of cables 200 connected to the plurality of first connection terminals 111, respectively, onto the printed circuit board 300.

Furthermore, connecting the plurality of cables 200 to the plurality of first connection terminals 111, respectively, includes: directly connecting connection ends of the plurality of cables 200 to one ends of the first connection terminals 111 by soldering, respectively; and combining the one ends of the plurality of first connection terminals 111 with the connection ends of the plurality of cables 200 by overmolding.

Furthermore, the connecting the plurality of second connection terminals 121 provided in the second housing 120 to the printed circuit board 300 includes: directly connecting one ends of the plurality of second connection terminals 121 to a plurality of pads on the printed circuit board 300, respectively.

Furthermore, the mounting a combination of the first housing 100, the plurality of first connection terminals 111 provided in the first housing 100, and the plurality of cables 200 connected to the plurality of first connection terminals 111, respectively, on the printed circuit board 300, includes: receiving the second housing 120, together with the plurality of second connection terminals 121, in a second slot of the first housing 100; and fixing the first housing 100, together with the plurality of first connection terminals 111 and the plurality of cables 200, on the printed circuit board 300 by a faster sequentially passing through a first fixing portion on the first housing 100 and a second fixing portion on the printed circuit board 300.

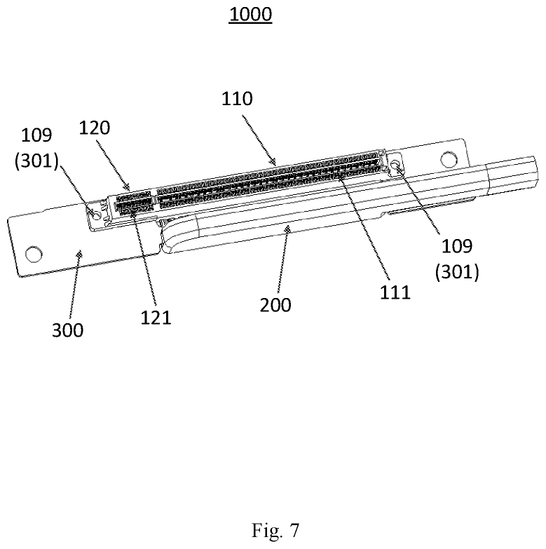

FIGS. 4 to 7 are schematic structural views showing various stages of a method of assembling a cable connector assembly 1000 according to an exemplary embodiment of the present disclosure, respectively.

Firstly, a connector 100 is provided. The connector 100 includes: a first housing 110; a plurality of first connection terminals 111 provided in the first housing 110; a second housing 120; and a plurality of second connection terminals 121 provided in the second housing 120. Here, the first housing 110 and the plurality of first connection terminals 111 provided therein form one independent body, the second housing 120 and the plurality of second connection terminals 121 provided therein form another independent body, and the two independent bodies are separated from each other.

Next, as shown in FIG. 4, the plurality of second connection terminals 121 provided in the second housing 120 are directly connected to the printed circuit board 300. Specifically, one ends of the plurality of second connection terminals 121 are directly connected to a plurality of pads on the printed circuit board 300 by soldering, respectively.

Subsequently, the plurality of cables 200 are directly connected to the plurality of first connection terminals 111 provided in the first housing 110, respectively. Connection ends of the plurality of cables 200 are directly connected to one ends of the plurality of first connection terminals 111 by soldering, respectively; and the one ends of the plurality of first connection terminals 111 are combined with the connection ends of the plurality of cables 200 by overmolding.

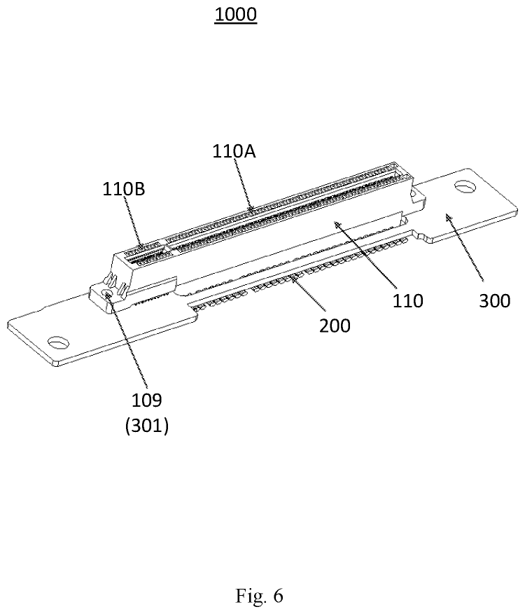

Then, as shown in FIGS. 5 and 6, a combination of the first housing 110, the plurality of first connection terminals 111 provided in the first housing 110, and the plurality of cables 200 directly connected to the plurality of first connection terminals 111, respectively, is mounted on the printed circuit board 300. The second housing 120, together with the plurality of second connection terminals 121, are received in a second slot 110B of the first housing 110. The first housing 110, together with the plurality of first connection terminals 111 and the plurality of cables 200, are fixed to the printed circuit board 300 by a fastener sequentially passing through the first fixing portion 109 on the first housing 110 and the second fixing portion 301 on the printed circuit board 300.

Finally, the plurality of cables 200 are bent around the printed circuit board 300 and the plurality of cables 200 are overmolded into one piece to obtain the assembled cable connector assembly 1000.

According to the method of assembling the cable connector assembly 1000 provided by the embodiments of the present disclosure, the assembling process is simplified and facilitated, and saves on assembling cost.

It should be appreciated by those skilled in this art that the above embodiments are intended to be illustrative, and many modifications may be made to the above embodiments by those skilled in this art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate embodiments of the present disclosure by way of example and should not be construed as a limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

It should be noted that, the word “comprise” or “include” doesn't exclude other elements or steps, and the word “a” or “an” doesn't exclude more than a plurality. In addition, any reference numerals in the claims should not be interpreted as the limitation to the scope of the present disclosure.

What is claimed is:

1. A cable connector assembly, comprising:
a connector including a first housing, a plurality of first connection terminals disposed in the first housing, a second housing, and a plurality of second connection terminals disposed in the second housing;
a plurality of cables respectively connected to the first connection terminals; and
a printed circuit board to which the second connection terminals are connected.

2. The cable connector assembly of claim 1, wherein a plurality of connection ends of the cables are each connected to one of a plurality of ends of the first connection terminals.

3. The cable connector assembly of claim 2, wherein the connection ends of the cables are connected to the ends of the first connection terminals by soldering.

4. The cable connector assembly of claim 2, wherein the ends of the first connection terminals are combined with the connection ends of the cables by overmolding.

5. The cable connector assembly of claim 1, wherein a plurality of ends of the second connection terminals are each connected to one of a plurality of pads on the printed circuit board.

6. The cable connector assembly of claim 5, wherein the ends of the second connection terminals are directly connected to the pads by soldering.

7. The cable connector assembly of claim 1, wherein the first housing has a first slot and a second slot independent of and integrated with the first slot.

8. The cable connector assembly of claim 7, wherein the first connection terminals are received in the first slot, the second housing and the second connection terminals are received in the second slot.

9. The cable connector assembly of claim 8, wherein the second housing and the second connection terminals are detachably received in the second slot.

10. The cable connector assembly of claim 1, wherein a pair of opposite ends of the first housing each have a first fixing portion.

11. The cable connector assembly of claim 10, wherein the printed circuit board has a pair of second fixing portions at positions corresponding to the opposite ends of the first housing.

12. The cable connector assembly of claim 11, wherein the first housing is fixed to the printed circuit board by a fastener sequentially passing through one of the first fixing portions and one of the second fixing portions.

13. The cable connector assembly of claim 1, wherein the printed circuit board has an elongated shape.

14. The cable connector assembly of claim 1, wherein the cables are flexible and bendable, the cables are bent around the printed circuit board.

15. The cable connector assembly of claim 1, wherein the connector is a female electrical connector.

16. A method of assembling a cable connector assembly, comprising:
providing a connector including a first housing, a plurality of first connection terminals disposed in the first housing, a second housing, and a plurality of second connection terminals disposed in the second housing;
connecting a plurality of cables to the first connection terminals;
connected the second connection terminals to a printed circuit board; and
mounting a combination of the first housing, the first connection terminals, and the cables connected to the first connection terminals onto the printed circuit board.

17. The method of claim 16, wherein connecting the cables to the first connection terminals includes directly connecting each of a plurality of connection ends of the cables to one of a plurality of ends of the first connection terminals by soldering.

18. The method of claim 17, wherein connecting the cables to the first connection terminals includes combining the ends of the first connection terminals and the connection ends of the cables by overmolding.

19. The method of claim 16, wherein connecting the second connection terminals to the printed circuit board includes directly connecting a plurality of ends of the second connection terminals to a plurality of pads on the printed circuit board by soldering.

20. The method of claim 16, wherein mounting the combination of the first housing, the first connection terminals, and the cables connected to the first connection terminals onto the printed circuit board includes:
receiving the second housing with the second connection terminals in a second slot of the first housing; and
fixing the first housing, with the first connection terminals and the cables, to the printed circuit board by a fastener passing through a first fixing portion on the first housing and a second fixing portion on the printed circuit board.
